(19) United States
(12) Patent Application Publication
(10) Pub. No.: US 2016/0136585 A1
(43) Pub. Date: May 19, 2016

(54) Composite Filtration Membranes from Conducting Polymer Nanoparticles and Conventional Polymers

(71) Applicant: The Regents of the University of California, Oakland, CA (US)

(72) Inventors: Eric M. V. Hoek, Pacific Palisades, CA (US); Yaozu Liao, Shanghai (CN); Richard B. Kaner, Pacific Palisades, CA (US)

(21) Appl. No.: 15/005,189

(22) Filed: Jan. 25, 2016

Related U.S. Application Data
(63) Continuation of application No. PCT/US2013/052348, filed on Jul. 26, 2013.

(51) Int. Cl. B01D 69/14; C02F 1/44; B01D 71/68; B01D 67/00; B01D 69/08; B01D 71/62

(52) U.S. Cl. CPC B01D 69/141; B01D 69/08; B01D 71/62; B01D 71/68; B01D 67/0013; C02F 1/445

(57) ABSTRACT

In one aspect, the invention relates to composite filtration membranes for use in, for example, water purification and concentrating a solute, and methods for making and using same. This abstract is intended as a scanning tool for purposes of searching in the particular art and is not intended to be limiting of the present invention.

### BACKGROUND

Fundamental advances in membrane technology that improve the efficiency of separations can lower costs, save time, and may someday lead to new devices such as wearable blood dialysis systems (Gaborski et al. ACS Nano 2010, 4(11): 6973-6981). In evaluating a membrane for use in a particular separation, there are criteria/figures of merit that determine the utility of a particular membrane: solvent permeability, target solute rejection, fouling resistance, and chemical and mechanical stability (Philip et al. ACS Appl. Mater. Interfaces 2010, 2(3): 847-853; Mehta et al. J. Membr. Sci. 2005, 249(1-2):245-249). Typical high-performance synthetic polymers commonly used in the formation of filtration membranes include polysulfone, polyethersulfone, and polyacrylonitrile (Nystrom et al. J. Membr. Sci. 1987, 60(2-3): 275-296; Barth et al. J. Membr. Sci. 2000, 169(2): 287-299; Su et al. Ind. Eng. Chem. Res. 2009, 48(6): 3136-3141). These polymers are known to be relatively inexpensive, chemically stable, soluble in common organic solvents, insoluble in water, and mechanically tough. However, filtration membranes formed from these polymers by nonsolvent induced phase separation (NIPS) generally show an inverse relationship between permeability and rejection. An important goal is to improve the permeability of a membrane, and thereby reduce the energy input and/or decrease the time needed to achieve separation without sacrificing selectivity. Another major obstacle in membrane separations is fouling by organic and inorganic species.

The incorporation of nanomaterials into polymer matrices to form nanocomposite membranes has become an important area of research (Lind et al. Langmuir 2009, 25(17): 10139-10145; Olubummo et al. ACS Nano 2012, 6(10): 8713-8727; Maximous et al. J. Membr. Sci. 2009, 341(1-2): 67-75; Baker et al. ACS Nano 2011, 5(5): 3469-3474; Zodrow et al. Water Res. 2009, 43(3): 715-723; Yang et al. Polymer 2006, 47(8): 2683-2688; Kim et al. Nano Lett. 2007, 7(9): 2806-2811). Previous work on adding nanomaterials into membranes has focused on microfiltration, filtration, nanofiltration, and reverse osmosis membranes (Pendergast et al. Energy Environ. Sci. 2011, 4(6): 1946-1971). However, progress in this field has been limited by the types of nanomaterials that can be incorporated into polymer membranes for performance enhancement. This limitation is mainly due to difficulties in ensuring appropriate interactions between filler nanomaterials and polymer in the mixed matrix—either promoting attraction or repulsion to minimize or maximize highly permeable interfacial regions. Much research has focused on compatibilizing zeolites, metal oxides, and mesoporous carbon nanoparticles with different polymers, but another approach is to begin with polymeric nanoparticles.

Prior research has produced polypyrrole (PPy) nanomaterials that are sufficiently processable for incorporation into filtration membranes (Liao et al. ACS Nano 2010, 4(9): 5193-5202). Other findings encourage further exploration of PPy as an anti-fouling and charged membrane material due to its anticipated conductivity, biocompatibility, and hydrophilicity (Guimard et al. Prog. Polym. Sci. 2007, 32(8-9): 876-921). Furthermore, incorporation of conductive nanomaterials into membranes may lead to “active transport” separation processes where an electro-stimuli can be used to control the transport of charged compounds through and away from a membrane surface (Zhou et al. React. Funct. Polym. 2000, 45(3): 217-226; Peng et al. Adv. Funct. Mater. 2007, 17(11): 1849-1855; Madaeni et al. Ionics 2010, 16(1): 75-80). Despite these advances, the incorporation of PPy nanoparticles into composite filtration membranes has previously not been realized.

### SUMMARY

In accordance with the purpose(s) of the invention, as embodied and broadly described herein, the invention, in one aspect, relates to nanocomposite membranes for use in, for example, water purification and concentrating a solute.

Disclosed are methods for making filtration membranes, the method comprising solution casting a polypyrrole-nanoparticle composite formed by dispersing polypyrrole nanoparticles in a polymer matrix, thereby providing the membrane.

Also disclosed are filtration membranes comprising (a) a solution cast polymer matrix; and (b) polypyrrole nanoparticles dispersed within the polymer matrix.

Also disclosed are methods for purifying water, the method comprising the steps of (a) providing a filtration membrane as disclosed herein, wherein the membrane has a first face and a second face; (b) contacting the first face of the membrane with a first solution of a first volume having a first solute concentration at a first pressure; and (c) contacting the second face of the membrane with a second solution of a second volume having a second solute concentration at a second pressure; wherein the first solution is in fluid communication with the second solution through the membrane; wherein the first solute concentration is higher than the second solute concentration, thereby creating an osmotic pressure across the membrane; and wherein the first pressure is sufficiently higher than the second pressure to overcome the osmotic pressure, thereby increasing the second volume and decreasing the first volume.

Also disclosed are methods for purifying water, the method comprising the steps of (a) providing a filtration membrane as disclosed herein, wherein the membrane has a first face and a second face; (b) contacting the first face of the membrane with a first solution of a first volume having a first solute concentration at a first pressure; and (c) contacting the second face of the membrane with a second solution of a second volume having a second solute concentration at a second pressure; wherein the first solution is in fluid communication with the second solution through the membrane; wherein the first solute concentration is higher than the second solute concentration, thereby creating an osmotic pressure across the membrane; and wherein the first pressure is sufficiently lower than the second pressure, thereby decreasing the second volume and increasing the first volume.

Also disclosed are methods for concentrating a solute, the method comprising the steps of (a) providing a filtration membrane as disclosed herein, wherein the membrane has a first face and a second face; contacting the first face of the membrane with a first mixture of a first volume having a first solute concentration at a first pressure; and contacting the second face of the membrane with a second mixture of a second volume having a second solute concentration at a second pressure; wherein the first solution is in fluid communication with the second solution through the membrane; wherein the first solute concentration is higher than the second solute concentration, thereby creating an osmotic pressure across the membrane; and wherein the first pressure is sufficiently higher than the second pressure to overcome the osmotic pressure, thereby increasing the first solute concentration and decreasing the second solute concentration.

Also disclosed are methods for concentrating a solute, the method comprising the steps of (a) providing a filtration membrane as disclosed herein, wherein the membrane has a first face and a second face; contacting the first face of the membrane with a first mixture of a first volume having a first solute concentration at a first pressure; and contacting the second face of the membrane with a second mixture of a second volume having a second solute concentration at a second pressure; wherein the first solution is in fluid communication with the second solution through the membrane; wherein the first solute concentration is higher than the second solute concentration, thereby creating an osmotic pressure across the membrane; and wherein the first pressure is sufficiently lower than the second pressure, thereby decreasing the first solute concentration and increasing the second solute concentration.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention.

FIG. 1a shows that as the PPy nanoparticle loading increases, the membrane color successively changes from white to brown to gray and then to black. PPy/PSf nanocomposite membranes prepared with 0, 2, 4, 10, and 20 wt % of PPy nanoparticles, respectively, in a wet state are depicted.

FIG. 1b shows that in a dry state the membranes display a very smooth and shiny surface, implying that smooth, thin-skinned filtration membranes have been formed. A PPy/PSf nanocomposite membrane prepared with 4 wt % PPy nanoparticles in a dry state is depicted.

FIG. 2 shows that the characteristic vibrational bands of PSf (occurring at 690, 834, 1160, 1240, and 1324 cm⁻¹) exhibit no chemical shifts with the addition of varying concentrations of PPy nanoparticles. This indicates an interaction typical of physical blending. Attenuated total reflection/Fourier transform infrared (ATR/FT-IR) spectra of PPy/PSf nanocomposite membranes prepared with (a) 0, (b) 2, (c) 4, (d) 10, and (e) 20 wt % of PPy nanoparticles are displayed.

FIG. 3 shows that the addition of PPy nanoparticles decreases the thickness of the membrane from ˜140 μm for a pure PSf membrane to 130 and then to 85 μm with 2 to 20 wt % PPy nanoparticles, respectively. Cross-sectional scanning electron microscopy (SEM) images of PPy/PSf nanocomposite membranes prepared with the addition of (a) 0, (b) 2, (c) 4, (d) 10, and (e) 20 wt % of PPy nanoparticles are displayed.

FIG. 4 shows that with increased PPy nanoparticle loading, the apparent membrane surface pore diameters increase and the surface becomes rougher. Surface SEM images of PPy/PSf nanocomposite membranes prepared with the addition of (a) 0, (b) 2, (c) 4, (d) 10, and (e) 20 wt % of PPy nanoparticles at 80,000× magnification are depicted.

FIG. 5 shows that the nanocomposite membranes with 10 wt % PPy nanoparticles show the highest surface roughness and porosity (5.6%) as determined by analyzing the SEM micrographs using NIH ImageJ software. Surface SEM images of PPy/PSf nanocomposite membranes prepared with the addition of (a) 0, (b) 2, (c) 4, (d) 10, and (e) 20 wt % of PPy nanoparticles, after contrast adjusted by NIH ImageJ software.

FIG. 6 shows that the surface roughness of the nanocomposite membranes appears to be greater than that of the pure PSf membrane, as illustrated with AFM images of (a) PSf and (b-e) PPy/PSf nanocomposite membranes with the addition of (b) 2, (c) 4, (d) 10, and (e) 20 wt % PPy nanoparticles.

FIG. 7 shows that in the range of the scan areas (1 μm×1 μm), the nanocomposite membranes exhibit the highest root-mean-square (RMS) roughness, average roughness (Rₐ), and maximum roughness (Rₘₐₓ) with values of 8.5, 6.5, and 60.9 nm, respectively, at a 10 wt % concentration of PPy nanoparticles, compared to 2.6, 3.3, and 24.5 nm for pure PSf membranes. Surface AFM histogram analyses of (a) PSf and (b-e) PPy/PSf nanocomposite membranes with the addition of (b) 2, (c) 4, (d) 10, and (e) 20 wt % of PPy nanoparticles are displayed.

FIG. 8 shows that the finger-like and sponge-like structures of the nanocomposite membranes show some individual or aggregated nanoparticles, which implies that the PPy nanoparticles have good miscibility with the PSf matrix. This leads to improved surface porosity and more interconnected cross-sectional morphologies. SEM images of PPy/PSf nanocomposite filtration membranes prepared with 4% PPy nanoparticles synthesized with hydrochloric acid (HCl) at the following areas: (a) cross-section at 2,000× magnification, (b) cross-section at 10,000× magnification, (c) top-surface, and (d) bottom-surface are displayed. The white arrows point to individual nanoparticles.

FIG. 9 shows that blending 4% of PPy nanoparticles with varying diameters into the PSf membranes exhibits increases in porosity and decreases in thickness of the nanocomposite membranes with the addition of relatively larger particle sizes of PPy nanoparticles. Cross-sectional SEM images of (a) a pure PSf and (b-e) PPy/PSf nanocomposite membranes prepared with (b) 85, (c) 110, (d) 200, and (e) 220 nm of PPy nanoparticles (4%) synthesized with (b) HCl, (c) HNO₃, (d) HClO₄, and (e) CSA, respectively.

FIG. 10 shows that blending 4 wt % of PPy nanoparticles with varying diameters into the PSf membranes exhibits increase in porosity of the nanocomposite membranes with the addition of relatively larger particle sizes of PPy nanoparticles. Surface SEM images of (a) a pure PSf and (b-e) PPy/PSf nanocomposite membranes prepared with (b) 85, (c) 110, (d) 200, and (e) 220 nm of PPy nanoparticles (4 wt %) synthesized with (b) HCl, (c) HNO₃, (d) HClO₄, and (e) CSA, respectively.

FIG. 11 shows that the PPy/PSf nanocomposite membranes demonstrate much higher zeta potentials compared to the pure PSf membranes.

FIG. 12 shows that the PPy/PSf nanocomposite membranes exhibit a slightly lower thermal stability than the pure PSf membrane up to 500° C. Although the nanocomposite membrane left a more massive residue at 1000° C. in comparison to the pure PSf membrane (47 vs. 30%), when the weight-loss is calculated by subtraction of the PPy mass, negligible differences between membranes are observed. Thermogravimetric analysis (TGA) and differential TGA (DTGA) scans of pure PSf membrane and PPy/PSf nanocomposite membranes prepared with the addition of 20 wt % PPy nanoparticles are displayed.

FIG. 13 shows that all PPy/PSf nanocomposite membranes demonstrate improvements in initial, compacted, fouled, and recovered permeability with the most notable improvements in the higher PPy content membranes (46.2 vs. 4.3, 22.2 vs. 4.0, 7.9 vs. 1.9, and 12.3 vs. 2.9 μM s⁻¹ psi⁻¹, respectively). Fouling experiments displaying the pure water flux measured as a function of time for membranes with varying PPy nanoparticle content are depicted.

FIG. 14 shows that membranes containing PPy nanoparticles were more permeable but also undergo less reversible and irreversible fouling.

FIG. 15 shows a schematic diagram illustrating the geometric structure for a typical size selective PPy/PSf nanocomposite membrane. Small molecules such as water readily pass through the membrane, while big particles such as BSA are mostly rejected.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

### A. DEFINITIONS

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

As used in the specification and the appended claims, the singular forms “a,” “an” and “the” include plural referents unless the context clearly dictates otherwise. Thus, for example, reference to “a functional group,” “an alkyl,” or “a residue” includes mixtures of two or more such functional groups, alkyls, or residues, and the like.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

As used herein, the terms “optional” or “optionally” means that the subsequently described event or circumstance can or cannot occur, and that the description includes instances where said event or circumstance occurs and instances where it does not.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an ethylene glycol residue in a polyester refers to one or more —OCH₂CH₂O— units in the polyester, regardless of whether ethylene glycol was used to prepare the polyester. Similarly, a sebacic acid residue in a polyester refers to one or more —CO(CH₂)₈CO— moieties in the polyester, regardless of whether the residue is obtained by reacting sebacic acid or an ester thereof to obtain the polyester.

As used herein, the term “polymer” refers to a relatively high molecular weight organic compound, natural or synthetic, whose structure can be represented by a repeated small unit, the monomer (e.g., polyethylene, rubber, cellulose). Synthetic polymers are typically formed by addition or condensation polymerization of monomers.

As used herein, the term “copolymer” refers to a polymer formed from two or more different repeating units (monomer residues). By way of example and without limitation, a copolymer can be an alternating copolymer, a random copolymer, a block copolymer, or a graft copolymer. It is also contemplated that, in certain aspects, various block segments of a block copolymer can themselves comprise copolymers.

As used herein, the term “oligomer” refers to a relatively low molecular weight polymer in which the number of repeating units is between two and ten, for example, from two to eight, from two to six, or form two to four. In one aspect, a collection of oligomers can have an average number of repeating units of from about two to about ten, for example, from about two to about eight, from about two to about six, or form about two to about four.

As used herein, the term “molecular weight” (MW) refers to the mass of one molecule of that substance, relative to the unified atomic mass unit u (equal to 1/12 the mass of one atom of carbon-12).

As used herein, the term “number average molecular weight” (Mₙ) refers to the common, mean, average of the molecular weights of the individual polymers. Mₙ can be determined by measuring the molecular weight of n polymer molecules, summing the weights, and dividing by n. Mₙ is calculated by:

$${\overline{M}}_{n} = \frac{{\sum }_{i} {N}_{i} {M}_{i}}{{\sum }_{i} {N}_{i}} ,$$

wherein Nᵢ is the number of molecules of molecular weight Mᵢ. The number average molecular weight of a polymer can be determined by gel permeation chromatography, viscometry (Mark-Houwink equation), light scattering, analytical ultracentrifugation, vapor pressure osmometry, end-group titration, and colligative properties.

As used herein, the term “weight average molecular weight” (M_{w}) refers to an alternative measure of the molecular weight of a polymer. M_{w} is calculated by:

$${\overline{M}}_{w} = \frac{{\sum }_{i} {N}_{i} {M}_{i}^{2}}{{\sum }_{i} {N}_{i} {M}_{i}} ,$$

wherein Nᵢ is the number of molecules of molecular weight Mᵢ. Intuitively, if the weight average molecular weight is w, and a random monomer is selected, then the polymer it belongs to will have a weight of w, on average. The weight average molecular weight can be determined by light scattering, small angle neutron scattering (SANS), X-ray scattering, and sedimentation velocity.

As used herein, the terms “polydispersity” and “polydispersity index” refer to the ratio of the weight average to the number average (M_{w}/Mₙ).

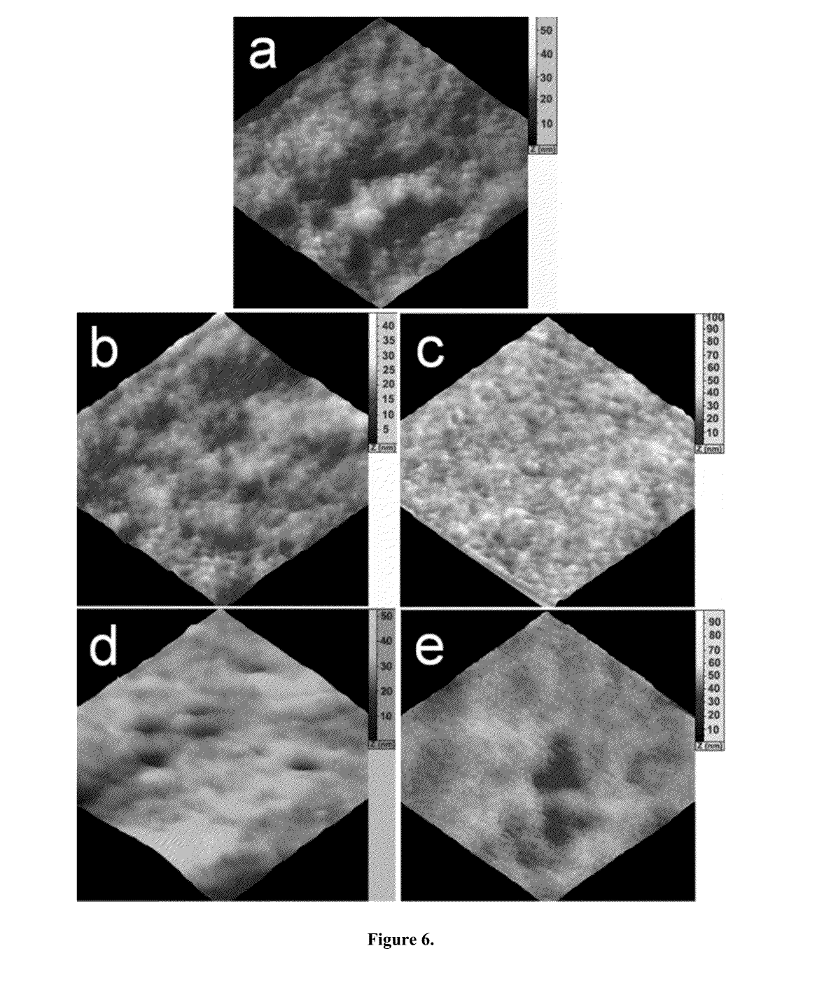

As used herein, the terms “flash welding” and “flash weld” refer to applying a pulse of light to an absorbing material. Flash welding can provide enhanced photothermal phenomena when performed on polymeric nanofibers. In certain aspects, the material rapidly converts the light to heat and then undergoes a transformation, such as melting. It is understood that, in certain aspects, chemical reactions can take place in the material as a consequence of flash welding (see, e.g., FIG. 7). Techniques for performing flash welding are described in U.S. Pat. No. 7,850,798 (“Flash welding of conducting polymers nanofibers”), issued Dec. 14, 2010, to J. Huang and R. B. Kaner.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplemental volumes (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. COMPOSITE FILTRATION MEMBRANES

In one aspect, the membranes of the invention can be composite filtration membranes comprising (a) a solution cast polymer matrix; and (b) polypyrrole nanoparticles dispersed within the polymer matrix. In a further aspect, the membrane is cast onto a support structure. In a still further aspect, the membrane is a hollow fiber membrane.

1. Nanocomposite Membranes

In one aspect, the membranes of the invention are nanocomposite (nanofiltration) membranes, which can result from the dispersion of nanoparticles such as polypyrrole nanoparticles into a polymer matrix. Typical high-performance synthetic polymers commonly used in the formation of nanocomposite membranes include polysulfone, polyethersulfone, and polyacrylonitrile. These nanocomposite membranes can be prepared, for example, by nonsolvent induced phase separation (NIPS).

One advantage of nanocomposite membranes having nanoparticles dispersed in the polymer matrix involves independent selection and modification of the nanoparticles to further optimize the selectivity of the membrane. The presence of nanoparticles, for example polypyrrole nanoparticles, can modify the polymer matrix of the membrane formed during NIPS and alter the macroscopic surface properties (e.g. surface charge, hydropholicity, porosity, thickness, and roughness) in a favorable manner, which can lead to improved selectivity.

Another advantage of nanocomposite membranes having nanoparticles dispersed in the polymer matrix involves the potential to impart passive fouling resistance to the support layer. Passive fouling resistance, sometimes referred to as “passivation,” describes modification of a surface to reduce surface reactivity and promote hydrophilicity. Passive fouling resistance can prevent unwanted deposition of dissolved, colloidal, or microbial matter on the membrane surface, which tends to foul the membrane and negatively influence flux and rejection.

The present invention provides a new class of nanocomposite filtration membranes with higher porosity, hydrophilicity, surface charge, thermal stability, and water permeability over conventional nanocomposite membranes. Development of more efficient, more selective membranes with tunable surface charge properties holds great promise for advanced protein separation, dialysis, water filtration, and other macro molecular separations.

In a further aspect, the membranes of the invention are nanofiltration membranes. In a still further aspect, the membrane is cast onto a support structure. In a still further aspect, the membrane is a hollow fiber membrane.

In a further aspect, the disclosed membranes have an average thickness of from about 75 μm to about 150 μm. In a still further aspect, the membranes have an average thickness of from about 85 μm to about 150 μm. In yet a further aspect, the membranes have an average thickness of from about 85 μm to about 140 μm. In an even further aspect, the membranes have an average thickness of from about 85 μm to about 130 μm.

In a further aspect, the disclosed membranes have an RMS surface roughness of less than about 10 nm.

In a further aspect, the disclosed membranes have a pure water equilibrium contact angle of less than about 60°. In a still further aspect, the membranes have a pure water equilibrium contact angle of less than about 50° C. In yet a further aspect, the membranes have a pure water equilibrium contact angle of less than about 45° C.

A. Nanocomposite Support Structure

In various aspects, the membrane is cast onto a support structure. In a further aspect, the support structure is a nonwoven support fabric. The support structure can be a porous polymeric support and can have particles of a size in the range of nanoparticles dispersed in the polymer. In a further aspect, the particles can be present in the support in an amount of at least about 0.1% by weight of the porous polymeric support.

B. Polymer Composition

While it is contemplated that the polymer matrix can comprise any three-dimensional polymer network known to those of skill in the art, in one aspect, the nanocomposite membrane comprises at least one of polysulfone, polyethersulfone, poly(ether sulfone ketone), poly(ether ethyl ketone), poly(phthalazinone ether sulfone ketone), polyacrylonitrile, polypropylene, cellulose acetate, cellulose diacetate, or cellulose triacetate, or a copolymer thereof or a mixture thereof. Typically, the polymer is selected to be a polymer that can be formed by an interfacial polymerization reaction or a polymer that can be cross-linked subsequent to polymerization.

In a further aspect, the polymer matrix comprises polysulfone, sulfonated polysulfone, polyethersulfone, sulfonated polyethersulfone, polyaniline, polyaniline co-polymers, polyacrylonitrile, polyvinylidene fluoride, polytetrafluoroethylene, other fluorocarbon derivatives or a mixture thereof. In a still further aspect, the polymer matrix comprises polysulfone

C. Nanoparticles

In one aspect, the nanoparticles of the invention are polypyrrole nanoparticles. In a further aspect, the polypyrrole nanoparticles are nanospheres. In various aspects, the nanoparticles used in connection with the membranes of the invention can be selected based upon a number of criteria, including one or more of: (1) an average particle size in the nanoscale region (e.g., having at least one dimension of a size of from about 1 nm to about 1,000 nm, for example, from about 1 nm to 500 nm, from about 1 nm to about 250 nm, or from about 1 nm to about 100 nm); (2) high hardness (relative to the polymer); (3) compatibility with the polymer used to prepare the support; and/or (4) dispersibility in the polymer used to prepare the support. Optionally, the nanoparticles can be selected so as to be modifiable to impart biocidal or antimicrobial reactivity to the membrane.

In a further aspect, the polypyrrole nanoparticles are present in an amount from about 0.1 wt % to about 30 wt %. In a still further aspect, the polypyrrole nanoparticles are present in an amount from about 0.1 wt % to about 25 wt %. In yet a further aspect, the polypyrrole nanoparticles are present in an amount from about 0.1 wt % to about 20 wt %. In an even further aspect, the polypyrrole nanoparticles are present in an amount from about 1.0 wt % to about 20 wt %. In a still further aspect, the polypyrrole nanoparticles are present in an amount from about 2.0 wt % to about 20 wt %. In yet a further aspect, the polypyrrole nanoparticles are present in an amount from about 3.0 wt % to about 20 wt %. In an even further aspect, the polypyrrole nanoparticles are present in an amount from about 4.0 wt % to about 20 wt %. In a still further aspect, the polypyrrole nanoparticles are present in an amount from about 5.0 wt % to about 20 wt %. In yet a further aspect, the polypyrrole nanoparticles are present in an amount from about 10 wt % to about 20 wt %. In an even further aspect, the polypyrrole nanoparticles are present in an amount from about 15 wt % to about 20 wt %. In a still further aspect, the polypyrrole nanoparticles are present in an amount of about 20 wt %.

(1) Particle Size

Particle size for nanoparticles is often described in terms of average hydrodynamic diameter, assuming a substantially spherical shape of the particles. While it is contemplated that the nanoparticles of the invention can be provided in any particle size known to those of skill in the art, the nanoparticles of the invention are, in one aspect, with an average hydrodynamic diameter of from about 1 nm to about 1000 nm, from about 10 nm to about 1000 nm, from about 20 nm to about 1000 nm, from about 50 nm to about 1000 nm, from about 80 nm to about 1000 nm, from about 1 nm to about 500 nm, from about 10 to about 500 nm, from about 20 nm to about 500 nm, from about 50 nm to about 500 nm, from about 80 nm to about 500 nm, from about 1 to about 300 nm, from about 10 to about 300 nm, from about 20 nm to about 300 nm, from about 50 nm to about 300 nm, or from about 80 nm to about 300 nm.

In a further aspect, the nanoparticles of the invention are polypyrrole nanoparticles. In a still further aspect the polypyrrole nanoparticles have a diameter of from about 75 nm to about 240 nm. In yet a further aspect, the polypyrrole nanoparticles have a diameter of from about 80 nm to about 240 nm. In an even further aspect, the polypyrrole nanoparticles have a diameter of from about 85 nm to about 240 nm. In a still further aspect, the polypyrrole nanoparticles have a diameter of from about 85 nm to about 230 nm.

2. Composite Ultrafiltration Membranes

In one aspect, the membranes of the invention are composite ultrafiltration membranes, which can result from the dispersion of particles such as polypyrrole nanoparticles into a solution cast polymer matrix. Typical high-performance synthetic polymers commonly used in the formation of ultrafiltration membranes include polysulfone, polyethersulfone, and polyacrylonitrile.

3. Osmosis Membranes

In one aspect, the membranes of the invention can be osmosis membranes, for example, forward osmosis membranes, reverse osmosis membranes, or pressure retarded osmosis membranes without thin film coating. Among particularly useful membranes for osmosis applications are those in which the discriminating layer is a polyamide.

Composite polyamide membranes are typically prepared by coating a porous support with a polyfunctional amine monomer, most commonly coated from an aqueous solution. Although water is a preferred solvent, non-aqueous solvents can be utilized, such as acetonitrile and dimethylformamide (DMF). A polyfunctional acyl halide monomer (also referred to as acid halide) is subsequently coated on the support, typically coated first on the porous support followed by the acyl halide solution. Although one or both of the polyfunctional amine and acyl halide can be applied to the porous support from a solution, they can alternatively be applied by other means such as by vapor deposition, or heat.

In a further aspect, the membranes of the invention can further comprise a thin film polymerized onto the surface of the solution cast membrane, and the membrane is an osmosis membrane.

4. Film

In various aspects, the membranes of the invention further comprise a thin film polymerized onto a surface of the solution cast membrane. The thin film can be a semi-permeable polymer matrix, e.g. with a three-dimensional polymer network, substantially permeable to water and substantially impermeable to solutes. For example, the polymer network can be a cross-linked polymer formed from reaction of at least one polyfunctional monomer with a difunctional or polyfunctional monomer.

The polymer matrix film can be a three-dimensional polymer network such as an aliphatic or aromatic polyamide, aromatic polyhydrazide, poly-bensimidazolone, polyepiamine/amide, polyepiamine/urea, a polyester, or a polyimide or a copolymer thereof or a mixture thereof. Preferably, the polymer matrix film can be formed by an interfacial polymerization reaction or can be cross-linked subsequent to polymerization.

The polymer matrix film can be an aromatic or non-aromatic polyamide such as residues of a phthaloyl (e.g., isophthaloyl or terephthaloyl) halide, a trimesyl halide, or a mixture thereof. In another example, the polyamide can be residues of diaminobenzene, triaminobenzene, polyetherimine, piperazine or poly-piperazine or residues of a trimesoyl halide and residues of a diaminobenzene. The film can also be residues of trimesoyl chloride and m-phenylenediamine. Further, the film can be the reaction product of trimesoyl chloride and m-phenylenediamine.

The polymer matrix film can have a thickness of from about 1 nm to about 1000 nm. For example, the film can have a thickness of from about 10 nm to about 1000 nm, from about 100 nm to about 1000 nm, from about 1 nm to about 500 nm, from about 10 nm to about 500 nm, from about 50 nm to about 500 nm, from about 50 nm to about 200 nm, from about 50 nm to about 250 nm, from about 50 nm to about 300 nm, or from about 200 nm to about 300 nm.

5. Properties

In various aspects, the composite filtration membranes of the invention can have various properties that provide the superior function of the membranes, including excellent flux, improved hydrophilicity, improved resistance to fouling, higher porosity, tunable surface charge properties, and higher thermal stability. It is also understood that the membranes have other properties.

A. Flux

The pure water flux of the membranes can be measured in a laboratory scale cross-flow membrane filtration apparatus. For example, the pure water flux can be measured in a high-pressure chemical resistant stirred cell (Sterlitech HP4750 Stirred Cell). In one aspect, the membranes can have a decline in flux of from about 45% to about 90%.

For example, the decline in flux can be from about 45% to about 90%, 50% to about 90%, 60% to about 90%, 70% to about 90%, 80% to about 90%.

B. Hydrophilicity

The hydrophilicity of the membranes can be expressed in terms of the pure water equilibrium contact angle. The contact angles of the membranes of the invention can be measured using a contact angle goniometer (DSA10, KRUSS GmbH). In one aspect, a membrane of the invention can have a pure water equilibrium contact angle of less than about 90°. For example, the contact angle can be less than about 75°, less than about 60°, less than about 45°, or less than about 30°. In a further aspect, the contact angle can be from about 60° to about 90°, from about 50° to about 80°, from about 40° to about 70°, from about 30° to about 60°, from about 20° to about 50°, or below 20°.

C. Resistance to Fouling

The relative biofouling potentials of the membranes of the invention can be evaluated by direct microscopic observation of microbial deposition and adhesion. (Kang et al. J. Membr. Sci. 2004, 244: 151-165.) Viability of bacteria adhered to membranes can be verified with a commercial viability staining kit (e.g., LIVE/DEAD® BacLight™ Bacterial Viability Kit, Molecular Probes, Inc., Eugene Oreg.) for 2-4 minutes, followed by observation using a fluorescence microscope (e.g., BX51, Olympus America, Inc., Melville, N.Y.). Living cells can be observed as green spots and dead (inactivated) cells are seen as red spots. (Li et al. Colloid. Surface. B 2005, 41: 153-161.)

D. Roughness

The surface topography of the synthesized membranes can be investigated by atomic force microscopy (AFM). Such investigation allows calculation of a root mean squared (RMS) roughness value for a membrane surface (Hoek et al. Langmuir 2003, 19: 4836-4847). In one aspect, a membrane of the invention can have an RMS surface roughness of less than about 50 nm. For example, the RMS surface roughness can be less than about 25 nm, less than about 20 nm, less than about 15 nm, less than about 10 nm, or less than about 5 nm.

### C. METHODS FOR MAKING FILTRATION MEMBRANES

In one aspect, the invention relates to a method for making a filtration membrane, the method comprising solution casting a polypyrrole-nanoparticle composite formed by dispersing polypyrrole nanoparticles in a polymer matrix, thereby providing the membrane.

In a further aspect, the polypyrrole nanoparticle composite is formed by phase inversion.

In a further aspect, the polypyrrole nanoparticles are nanospheres.

In a further aspect, the membrane is cast onto a support structure. In a still further aspect, the support structure is a nonwoven support fabric.

In a further aspect, the membrane is a hollow fiber membrane.

In a further aspect, the polymer matrix is in a solvent suspension. In a still further aspect, the polymer matrix is in a solvent solution.

In a further aspect, the polymer matrix is selected from at least one of polysulfone, polyethersulfone, poly(ether sulfone ketone), poly(ether ethyl ketone), poly(phthalazinone ether sulfone ketone), polyacrylonitrile, polypropylene, cellulose acetate, cellulose diacetate, or cellulose triacetate, or a copolymer thereof or a mixture thereof. In a still further aspect, the polymer matrix is polysulfone.

In a further aspect, solution casting is nonsolvent induced phase separation.

In a further aspect, the filtration membrane is selected from a nanofiltration membrane, an ultrafiltration membrane, a reverse osmosis membrane, a forward osmosis membrane, or a pressure retarded osmosis membrane without thin film coating. In a still further aspect, the filtration membrane is a nanofiltration membrane. In yet a further aspect, the filtration membrane is an ultrafiltration membrane.

In a further aspect, the method further comprises the step of polymerizing a thin film onto a surface of the solution cast membrane, thereby providing an osmosis membrane. In a still further aspect, the osmosis membrane is selected from a forward osmosis membrane, or a reverse osmosis membrane.

It is understood that the disclosed methods can be used to provide the disclosed membranes.

### D. METHODS FOR PURIFYING WATER WITH SEMI-PERMEABLE MEMBRANES

The invention can be used as a filtration membrane for performing water purification, bioseparations, protein purification, oil-water separations, etc.

Thus, in one aspect, the invention relates to a method for purifying water, the method comprising the steps of: (a) providing a disclosed filtration membrane, wherein the membrane has a first face and a second face; (b) contacting the first face of the membrane with a first solution of a first volume having a first solute concentration at a first pressure; and (c) contacting the second face of the membrane with a second solution of a second volume having a second solute concentration at a second pressure; wherein the first solution is in fluid communication with the second solution through the membrane; wherein the first solute concentration is higher than the second solute concentration, thereby creating an osmotic pressure across the membrane; and wherein the first pressure is sufficiently higher than the second pressure to overcome the osmotic pressure, thereby increasing the second volume and decreasing the first volume.

In one aspect, the invention relates to a method for purifying water, the method comprising the steps of: (a) providing a disclosed filtration membrane, wherein the membrane has a first face and a second face; (b) contacting the first face of the membrane with a first solution of a first volume having a first solute concentration at a first pressure; and (c) contacting the second face of the membrane with a second solution of a second volume having a second solute concentration at a second pressure; wherein the first solution is in fluid communication with the second solution through the membrane; wherein the first solute concentration is higher than the second solute concentration, thereby creating an osmotic pressure across the membrane; and wherein the first pressure is sufficiently lower than the second pressure, thereby decreasing the second volume and increasing the first volume.

It is understood that the disclosed purification methods can be used in connection with the disclosed membranes. It is also understood that the disclosed purification methods can be used in connection with the products of the disclosed methods.

### E. METHODS FOR CONCENTRATING A SOLUTE

In one aspect, the invention relates to a method for concentrating a solute, the method comprising the steps of (a) providing a filtration membrane as disclosed herein, wherein the membrane has a first face and a second face; contacting the first face of the membrane with a first mixture of a first volume having a first solute concentration at a first pressure; and contacting the second face of the membrane with a second mixture of a second volume having a second solute concentration at a second pressure; wherein the first solution is in fluid communication with the second solution through the membrane; wherein the first solute concentration is higher than the second solute concentration, thereby creating an osmotic pressure across the membrane; and wherein the first pressure is sufficiently higher than the second pressure to overcome the osmotic pressure, thereby increasing the first solute concentration and decreasing the second solute concentration.

In one aspect, the invention relates to a method for concentrating a solute, the method comprising the steps of (a) providing a filtration membrane as disclosed herein, wherein the membrane has a first face and a second face; contacting the first face of the membrane with a first mixture of a first volume having a first solute concentration at a first pressure; and contacting the second face of the membrane with a second mixture of a second volume having a second solute concentration at a second pressure; wherein the first solution is in fluid communication with the second solution through the membrane; wherein the first solute concentration is higher than the second solute concentration, thereby creating an osmotic pressure across the membrane; and wherein the first pressure is sufficiently lower than the second pressure, thereby decreasing the first solute concentration and increasing the second solute concentration.

Typically, the membranes of the invention can be prepared so as to be substantially impermeable to solutes. As used herein, “solute” generally refers to materials dissolved, dispersed, or suspended in a liquid. The materials can be undesired; in such a case, the membranes can be used to remove the undesired solute from the liquid, thereby purifying the liquid, and the liquid can be subsequently collected. The materials can be desired; in such a case, the membranes can be used to decrease the volume of the liquid, thereby concentrating the solute, and the solute can be subsequently collected. In one aspect, the membranes can be provided to be substantially impermeable to particular solutes, which can be selected from among solutes known to those of skill in the art. In a further aspect, the solutes can comprise at least one of sodium ions, potassium ions, magnesium ions, calcium ions, silicates, organic acids, or nonionized dissolved solids with a molecular weight of greater than about 200 Daltons or a mixture thereof. The solutes can be dissolved or dispersed within a liquid. The solutes can be hydrophobic or hydrophilic or neither or a mixture thereof. Exemplary solutes can include ions, neutral species, silicates, and organic compounds, for example, amines or carboxylic acids.

Ions can be monovalent ions, divalent ions, trivalent ions, higher valent ions, or a mixture thereof. In one aspect, the solutes comprise monovalent ions. The ions can be positive ions, negative ions, or a mixture thereof. Monovalent metal ions include lithium ions, sodium ions, potassium ions, rubidium ions, cesium ions, francium ions, ammonium ions, protonated primary amine ions, protonated secondary amine ions, and protonated tertiary amine ions. In addition, monovalent ions can be dissociated mineral or organic acids. In a further aspect, one or more of these types of ions are not among the solutes wherein a membrane of the invention is substantially impermeable.

In a further aspect, the solutes comprise divalent ions. The ions can be positive ions, negative ions, or a mixture thereof. Divalent ions include beryllium ions, magnesium ions, calcium ions, strontium ions, radium ions, ferrous iron, barium ions, and protonated diamines. In addition, divalent ions can be dissociated mineral or organic acids. In a further aspect, one or more of these types of ions are not among the solutes wherein a membrane of the invention is substantially impermeable.

In a further aspect, the solutes comprise higher valent ions. The ions can be positive ions, negative ions, or a mixture thereof. Higher valent ions include aluminum ions, ferric iron ions, or silica ions. In a further aspect, one or more of these types of ions are not among the solutes wherein a membrane of the invention is substantially impermeable.

Neutral species can include, for example, nonionized solids with a molecular weight of greater than about 200 Daltons. The molecular weight can be, for example, at least about 200 Daltons, at least about 250 Daltons, at least about 300 Daltons, at least about 250 Daltons, at least about 400 Daltons, at least about 500 Daltons, at least about 600 Daltons, at least about 700 Daltons, at least about 800 Daltons, at least about 900 Daltons, or at least about 1,000 Daltons. The neutral species can be dissolved or suspended. The neutral species can be hydrophobic, hydrophilic, both, or neither. In a further aspect, one or more of these types of neutral species are not among the solutes wherein a membrane of the invention is substantially impermeable.

Silicates can include all known compounds of Silicon and Oxygen based upon the SiO₄ tetrahedron-shaped anionic group, with or without one or more metal ions present. It is understood that the silicates can be present as solids with a molecular weight of greater than about 200 Daltons and can be dissolved or suspended. The molecular weight can be, for example, at least about 250 Daltons, at least about 300 Daltons, at least about 250 Daltons, at least about 400 Daltons, at least about 500 Daltons, at least about 600 Daltons, at least about 700 Daltons, at least about 800 Daltons, at least about 900 Daltons, or at least about 1,000 Daltons. In a further aspect, one or more of these types of silicates are not among the solutes wherein a membrane of the invention is substantially impermeable.

Organic acids can include formic acid, acetic acid, propionic acid, butyric acid, pentanoic acid, hexanoic acid, heptanoic acid, octanoic acid, nonanoic acid, decanoic acid, and lactic acid and derivatives and mixtures thereof. Also included are phenols and derivatives and mixtures thereof, in addition to naturally occurring humic and fulvic acids or biopolymers comprising amino acids, proteins, or complex polysaccharidic acids. The acids can be protonated or deprotonated. In a further aspect, one or more of these types of organic acids are not among the solutes wherein a membrane of the invention is substantially impermeable.

In a further aspect, the solutes can be the product of a chemical or biological reaction, screening assay, or isolation technique. For example, the solutes can be a chemically active agent, a pharmaceutically active agent, or a biologically active agent or a mixture thereof. In yet a further aspect, one or more of these types of agents are not among the solutes wherein a membrane of the invention is substantially impermeable.

### F. EXPERIMENTAL

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Materials

All chemicals including pyrrole, 2,4-diaminodiphenylamine, ferric chloride (FeCl₃), hydrochloric acid (HCl), 1-methyl-2-pyrrolidinone (NMP), polysulfone (PSf, ˜22,000 by MO), bovine serum albumin (BSA, ˜66 kDa) were purchased from Sigma-Aldrich. Potassium chloride (KCl), sodium hydroxide (NaOH), and sodium chloride (NaCl) were purchased from Fisher Scientific. All the materials were chemical grade and used as received.

2. Synthesis of Polypyrrole (PPy) Nanoparticles

0.5 g of pyrrole and 0.15 g of 2,4-diaminodiphenylamine (10 mol % relative to pyrrole) as an initiator were dissolved in 0.3 L of methanol, while 1.2 g of FeCl₃ as an oxidant was dissolved in 0.3 L of 1.0 mol L⁻¹ of HCl. The two solutions were cooled to 0° C. and rapidly mixed. The reaction was vigorously shaken for 10-15 s by hand and then left undisturbed overnight. The as-synthesized products were purified by centrifugation at a speed of 4500 rpm min⁻¹ using DI water/methanol (90/10) at 15° C. until the supernatant became colorless. A black powder was obtained by drying the above solution at 50° C. for one week to remove all the water. The structure, morphology, and size measurements of the PPy nanoparticles are presented elsewhere (Liao et al. ACS Nano 2010, 4(9): 5193-5202).

3. Membrane Formation Via Nonsolvent Induced Phase Separation (NIPs)

To prepare the filtration membranes five compositions (0, 30, 60, 150 and 300 mg) of polypyrrole nanoparticles were dispersed in 6.83 g of N-methyl-2-pyrrolidone (NMP) and then 1.5, 1.47, 1.44, 1.35, and 1.2 g of polysulfone beads were added, respectively. The mixtures consisting of 1.5 g polymers and 6.83 g of NMP were stirred at 50° C. overnight to produce casting solutions at fixed concentration of 18 wt % with five PPy concentrations (0, 2, 4, 10, and 20 wt %) used for all the polymers. The solutions were cast on a commercial nonwoven polyester support fabric and then immersed in 18 MΩ laboratory deionized water at room temperature to induce precipitation by a solvent/non-solvent (NMP/water) exchange to form homogeneous filtration membranes.

4. Measurements and Characterization

The morphologies of the pure PSf and PPy/PSf nanocomposite membranes were observed by a JEOL JSM-6700 field emission SEM. FT-IR spectra of the membranes were recorded on a JASCO ATR/FT-IR-620 spectrometer. TGA/DTGA scans of the membranes without the support fabric were carried out on a Perkin Elmer TGA Pyris 1 by heating the samples from room temperature to 1000° C. at a rate of 10° C. min⁻¹. The hydrophilicity of all the filtration membranes was determined by the captive bubble technique using a DSA10 Kruss goniometer with at least seven contact angle measurements performed across each membrane coupon at equally spaced intervals. Streaming current was measured using an adjustable gap electrokinetic analyzer (SurPASS Electrokinetic Analyzer, Anton-Paar GmbH). The flow channel gap was set at 100 μm, and a 1 mM KCl solution at 20° C. was used as the background electrolyte. Streaming current was determined in a pH range of 2-10, adjusted using HCl and NaOH. Membrane zeta potential (c) was calculated using the Helmholtz-Smoluchowski equation (1),

$$ζ = \frac{d I}{d p} \cdot \frac{μ}{ɛ \cdot {ɛ}_{0}} \cdot \frac{L}{A} \qquad ( 1 )$$

where dI/dp is the slope of the streaming current versus pressure, μ is the solution dynamic viscosity, E is the dielectric constant of the solution, ∈₀ is the vacuum permittivity, L is the streaming channel length and A is the cross-section of the streaming channel. MQ water initial permeability and BSA rejection tests were conducted in a Batch-type UHP-25 K filtration apparatus under a transmembrane pressure of ˜10 psi at 25° C. The permeability was determined for each membrane by slowly increasing pressure to maintain a pure water flux of 0.421 mL min⁻¹ until a flux decline of less than 5% was observed over an hour. BSA with a diameter of ˜6 nm was used to evaluate the membrane bio-separation performance. BSA concentrations in the permeate streams (Cₚ) and feed streams (C_{f}) were determined by an HP 8453 UV-vis spectrophotometer. Solute particle rejection (r) was calculated by the equation, r=(1−Cₚ/C_{f})×100%. Permeability and rejection for each membrane were measured five times and then averaged. The surface average pore diameters (dₚ) of the membranes were approximated from BSA rejection by using the equation (2) (Guillen et al. J. Mater. Chem. 2010, 20(22): 4621-4628; Crittenden, J. et al. (2005). Water Treatment: Principles and Design (2^{nd} ed) Hoboken: John Wiley & Sons, Inc.),

λ=1−\sqrt{1−\sqrt{r}} (2)

where λ=dₛ/dₚ, dₛ is BSA diameter of ˜6 nm, 0<r<1.

### G. RESULTS AND DISCUSSION

1. Chemical Structure and Morphology of PPy/PSf Nanocomposite Membranes

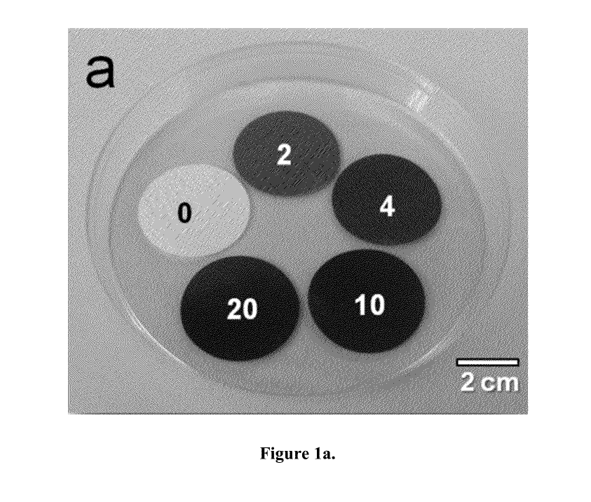

The structure, morphology, and dimensions of PPy nanoparticles have been described in great detail elsewhere (Liao et al. ACS Nano 2010, 4(9): 5193-5202. Membranes of varying PPy and PSf content were formed using the NIPS precipitation technique as described herein. Photographs of each membrane in a wet state are shown in FIG. 1a. As the nanoparticle loading increases, the membrane color successively changes from white to brown to gray and then to black. When dried, the membranes display a very smooth and shiny surface (FIG. 1b), implying that smooth, thin-skinned filtration membranes have been formed.

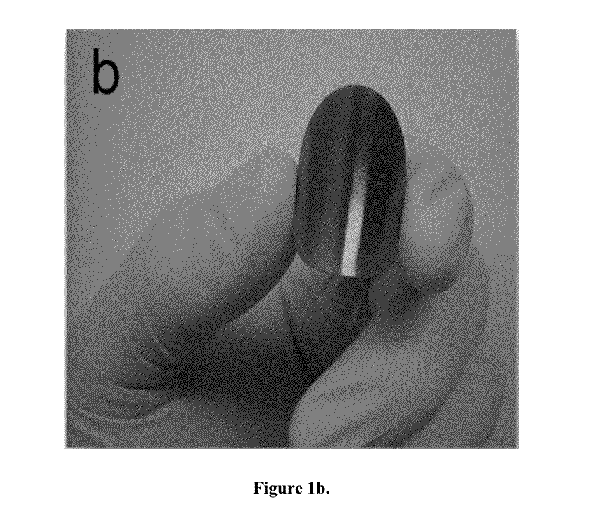

The attenuated total reflection/Fourier transform infrared (ATR/FT-IR) spectra of the pure PSf and PPy/PSf nanocomposite membranes are shown in FIG. 2. The characteristic vibrational bands of PSf occur at 690, 834, 1160, 1240, and 1324 cm⁻¹ due to the C-S-C linkage, the aromatic rings, the symmetric sulfone, the aromatic ether, and an asymmetric sulfone, respectively (Sur et al. Polymer 2001, 42(24): 9783-9789; Yeh et al. J. Appl. Polym. Sci. 2004, 92(1): 631-637; Chennamsetty et al. Langmuir 2008, 24(10): 5569-5579). With addition of varying concentrations of PPy nanoparticles, the characteristic bands attributed to PSf exhibit no chemical shifts, indicating an interaction typical of physical blending.

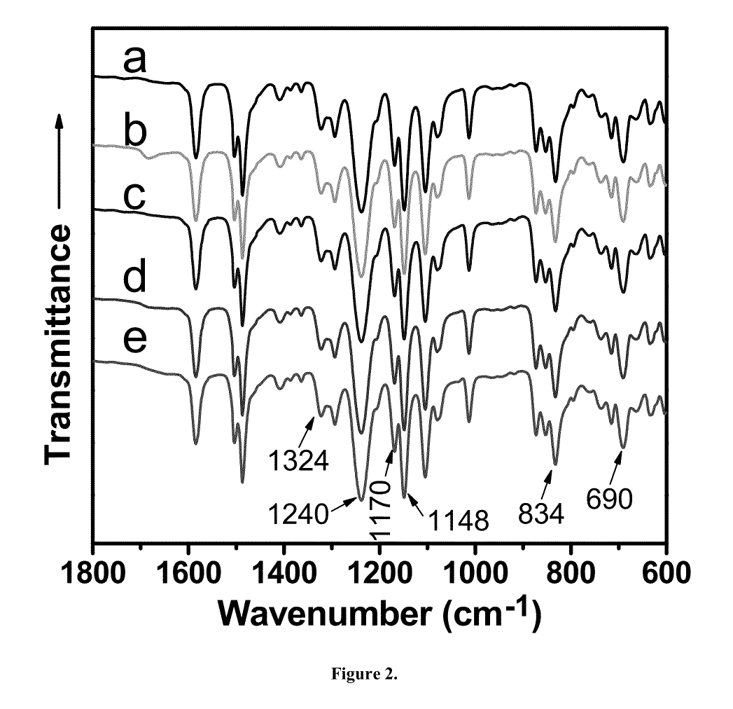

FIGS. 3-8 show the cross-sectional and surface morphologies of membranes with different concentrations of PPy nanoparticles with diameters of ˜85 nm, as observed by scanning electron microscopy (SEM). The cross-sectional morphologies of the pure PSf and nanocomposite membranes consist of a relatively dense, nanoporous top layer (1-2 μm thick) and a porous sublayer with large macrovoids (FIG. 3). However, the finger-like structures in the nanocomposite membranes, especially in the membranes containing 10 wt % PPy nanoparticles, appear more interconnected than those of the pure PSf membrane, perhaps due to more cavities left by the migration of PPy nanoparticles during solvent-exchange. Additionally, it appears that macrovoid formation is reduced in the nanocomposite membranes, producing a more sponge-like morphology (FIG. 3, insets). A pure PSf membrane without the support has a thickness of ˜140 μm, whereas the values decreased to 130 and then to 85 μm with 2 to 20 wt % PPy nanoparticles, respectively, as shown in FIGS. 3a-e.

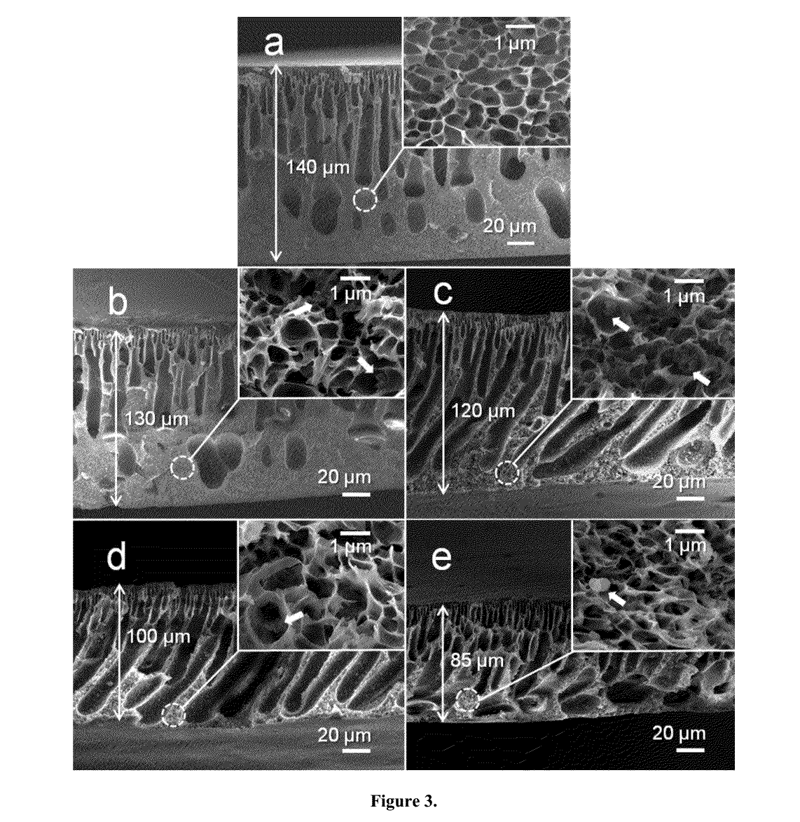

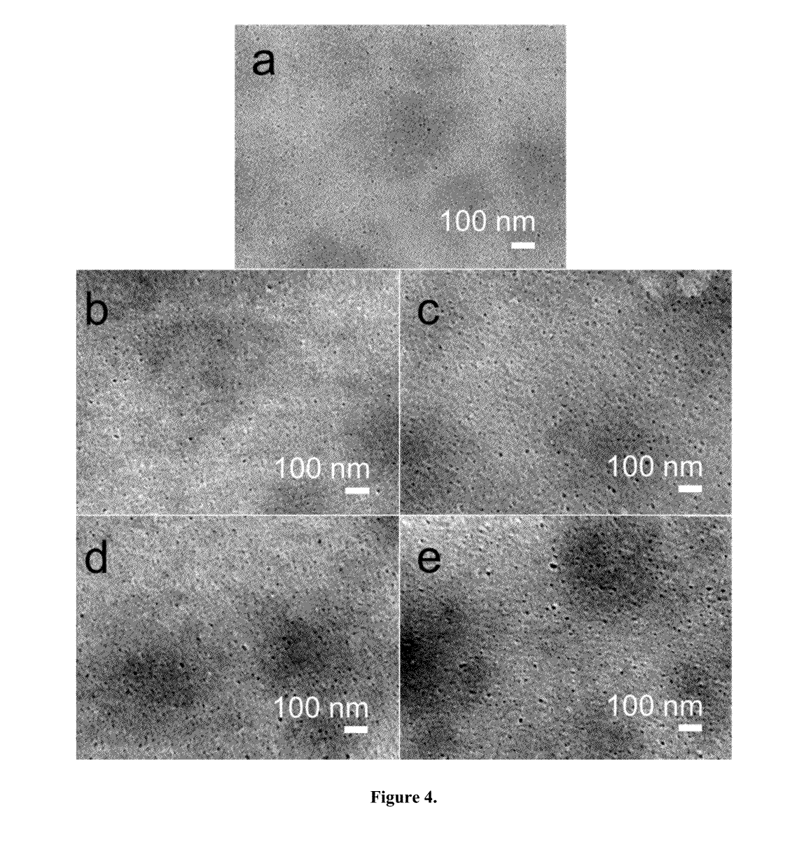

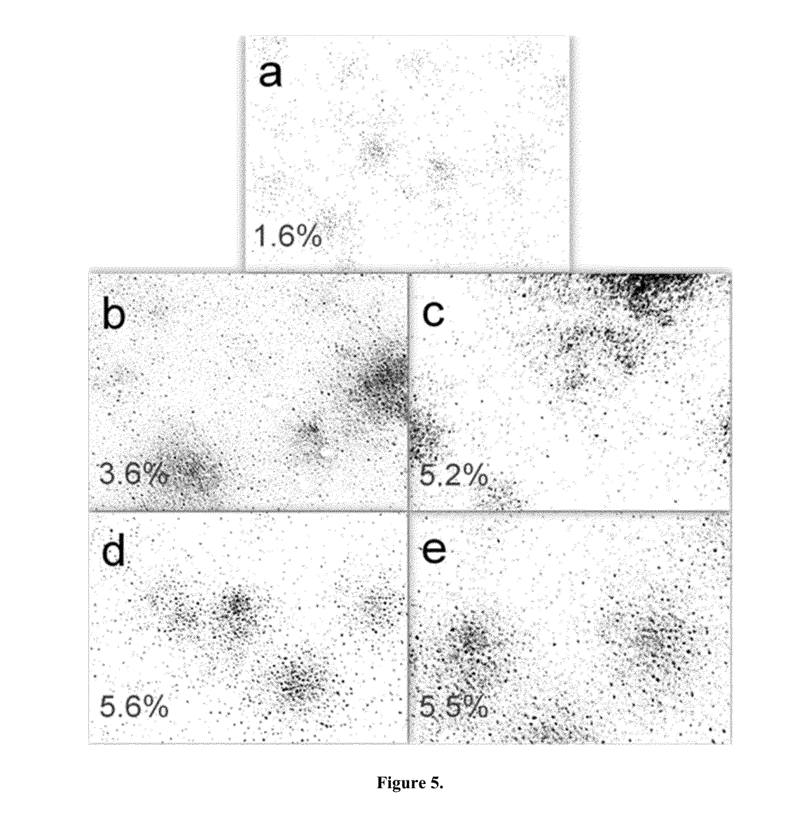

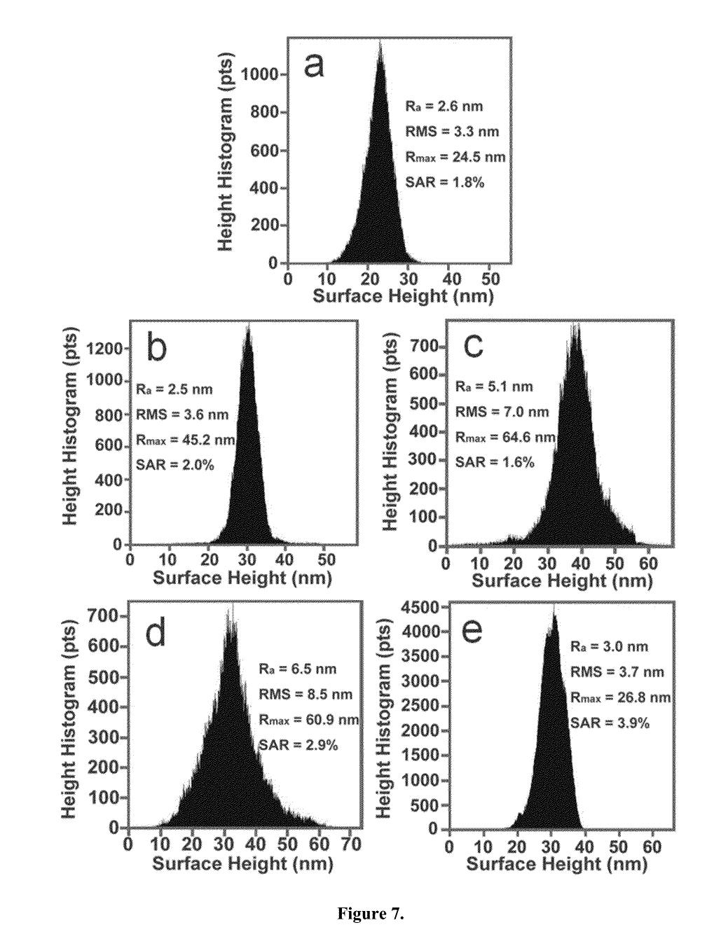

With increased PPy nanoparticle loading, the apparent membrane surface pore diameters increase and the surface becomes rougher (FIG. 4). The nanocomposite membranes with 10 wt % PPy nanoparticles show the highest surface roughness and porosity (5.6%) as determined by analyzing the SEM micrographs using NIH ImageJ software (Guillen et al. J. Mater. Chem. 2010, 20(22): 4621-4628) (FIG. 5). Atomic force microscopy (AFM) was also used for morphological characterization of the membrane surface to complement SEM. According to the 3D AFM images and histogram analyses of the membranes (FIGS. 6 and 7), the morphological characterization results are presented in Table 1, elucidating a few trends corresponding to the different concentrations of PPy nanoparticles. Generally, with the addition of PPy nanoparticles, the surface roughness of the nanocomposite membranes appears to be greater than that of the pure PSf membrane. In the range of the scan areas (1 μm×1 μm), the nanocomposite membranes exhibit the highest root-mean-square (RMS) roughness, average roughness (Rₐ), and maximum roughness (Rₘₐₓ) with values of 8.5, 6.5, and 60.9 nm, respectively, at a 10 wt % concentration of PPy nanoparticles, compared to 2.6, 3.3, and 24.5 nm for pure PSf membranes. However, with a further increase in the concentration of PPy nanoparticles up to 20 wt %, the surface structure starts to become smooth again. The huge change in Rₐ, RMS, and Rₘₐₓ, but small change in surface area difference (SAD), is evidence that homogeneous and smooth PPy/PSf nanocomposite membranes have been created. Moreover, PPy nanoparticles were observed in both the top and bottom surfaces of the nanocomposite membranes (FIGS. 8c and 8d), indicating that the increased roughness may be caused by the accumulation of hydrophilic PPy nanoparticles on the membrane surface. Even the finger-like and sponge-like structures of the nanocomposite membranes show some individual or aggregated nanoparticles, as indicated in FIG. 3b-e (insets), and FIGS. 8a and 8b. This implies that the PPy nanoparticles have good miscibility with the PSf matrix, leading to improved surface porosity and more interconnected cross-sectional morphologies.

TABLE 1
Properties of the PSf and PPy/PSf Nanocomposite Membranes

| | Rₐ | RMS | Rₘₐₓ | SAD |
|---|---|---|---|---|
| Membrane | (nm) | (nm) | (nm) | (%) |
| PSf | 2.6 | 3.3 | 24.5 | 1.8 |
| 2 wt % PPy | 2.5 | 3.6 | 45.2 | 2.0 |
| 4 wt % PPy | 5.1 | 7.0 | 64.6 | 1.6 |
| 10 wt % PPy | 6.5 | 8.5 | 60.9 | 2.9 |
| 20 wt % PPy | 3.0 | 3.7 | 26.8 | 3.9 |

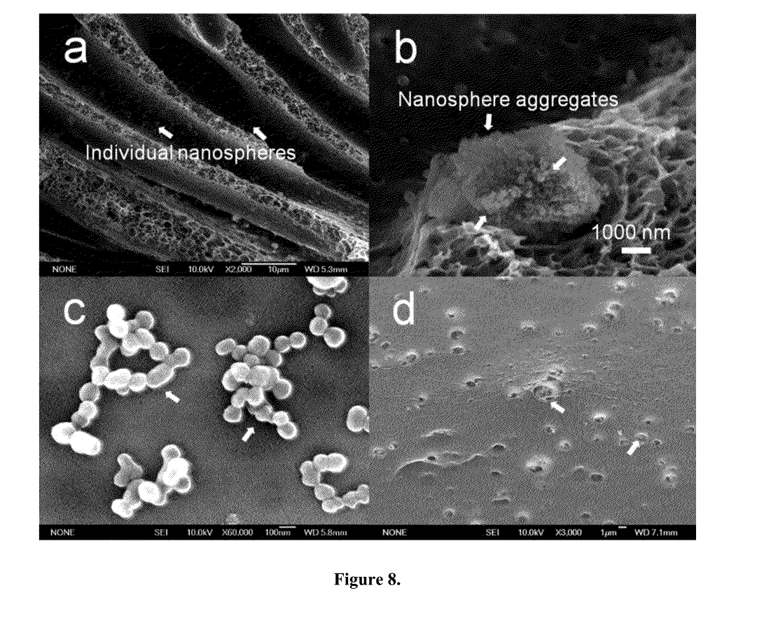

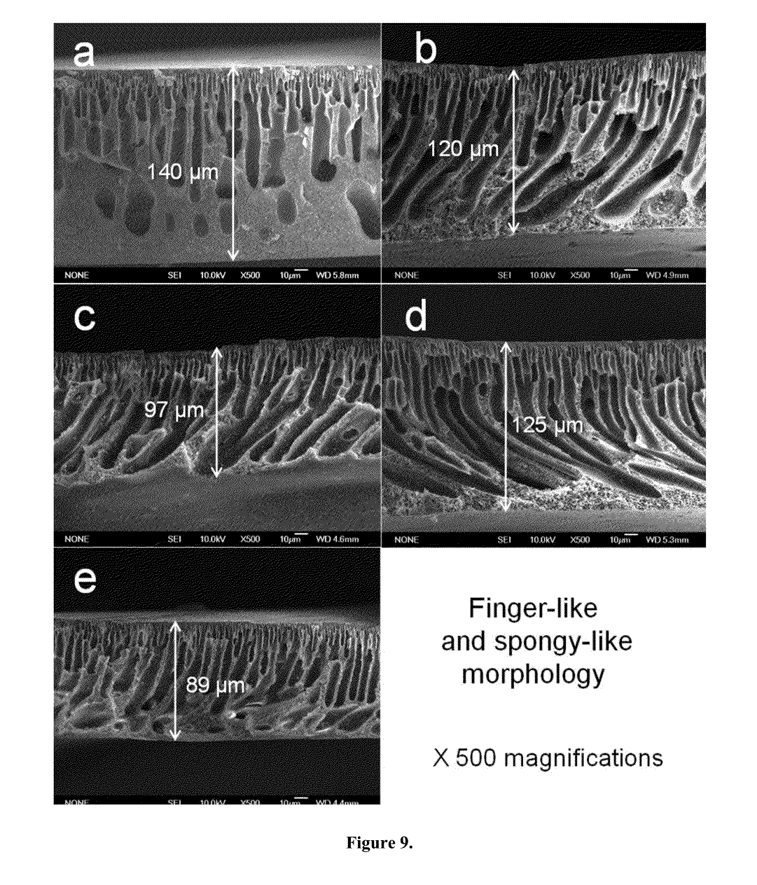

Additionally, different sized PPy nanoparticles with diameters of 85, 110, 200, and 220 nm were synthesized using hydrochloric acid (HCl), nitric acid (HNO₃), perchloric acid (HClO₄), and camphorsulfonic acid (CSA), respectively. When the same concentration of PPy nanoparticles (4 wt %) were blended into the PSf membranes, increases in porosity and decreases in thickness of the nanocomposite membranes are observed with the addition of relatively larger particle sizes of PPy nanoparticles, as shown in FIGS. 9 and 10. This also suggests that the observed differences in membrane thickness are due to the effects of PPy nanoparticles on macrovoid morphology rather than on the decreasing PSf content.

2. Hydrophobilicity, Charged Surfaces, and Thermal Stability

The influence of PPy nanoparticle loading on the hydrophilicity and surface energy of these composite membranes is presented in Table 2. Note that upon addition of only 2 wt % PPy nanoparticles, the contact angles of the resulting nanocomposite membranes (54°) become lower than that of pure PSf membranes (65°). The contact angle is further decreased to ˜42° when the concentration of PPy nanoparticles is increased to 4 wt %. Then, the contact angles remain relatively constant with values of 42-46° when 10-20 wt % PPy nanoparticles were added. On the basis of surface roughness corrected by AFM, solid-liquid interfacial free energies (−ΔG₁₃) of the pure PSf and nanocomposite membranes were calculated from the contact angles and SAD values as previously described (Ghosh et al. J. Membr. Sci. 2008, 311(1-2): 34-45). As expected, the pure PSf membrane is the most hydrophobic, and the membrane surface energies generally increase with increasing PPy concentration.

TABLE 2
Effect of PPy nanoparticles on
hydrophilicity and surface energy

| Contact | −ΔG₁₃ | dₚ |
|---|---|---|
| Angle (°) | (mJ m⁻²) | (nm) |
| 64.7 ± 3.8 | 103.4 | 7.7 |
| 54.0 ± 5.8 | 114.8 | 7.0 |
| 42.1 ± 0.7 | 126.0 | 7.2 |
| 45.6 ± 4.1 | 122.3 | 7.5 |
| 42.9 ± 2.0 | 124.1 | 8.2 |

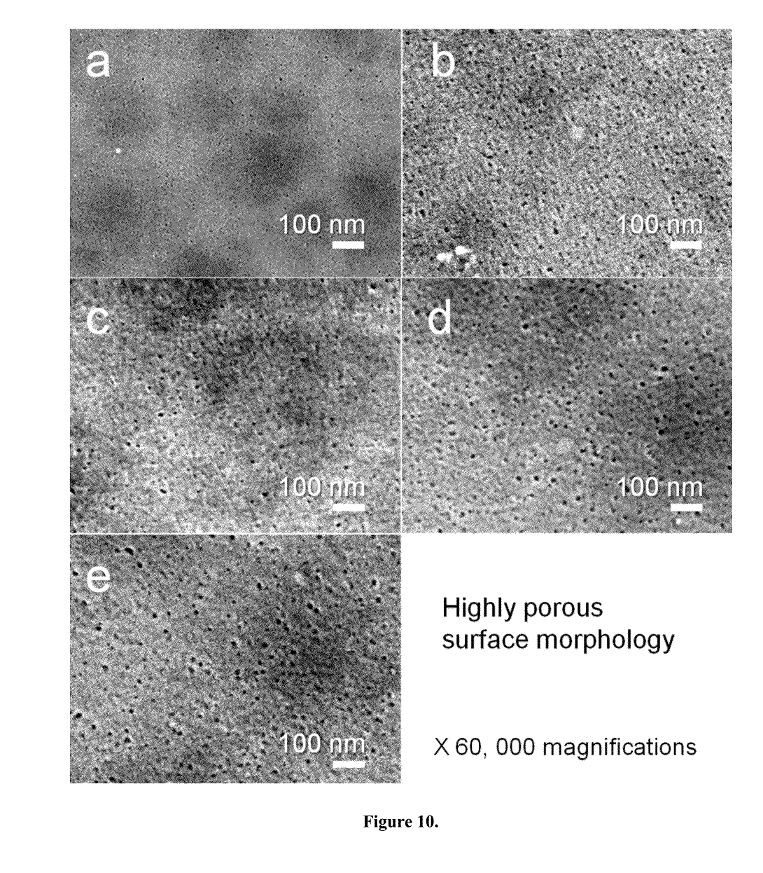

Zeta potential measurements for the pure PSf and nanocomposite membranes are shown in FIG. 11 as a function of streaming pH. The decrease in zeta potential as pH increases is a typical characteristic of polymeric membranes (Childress et al. J. Membr. Sci. 1996, 119(2): 253-268; Schaep et al. Sep. Purif. Technol. 2001, 22-23(1-3): 169-179). The PPy/PSf nanocomposite membranes have amine, amino, and sulfone groups which will be protonated at low pH leading to a positive charge (i.e., a positive zeta potential); the groups will be deprotonated as the pH increases, causing the membrane charge to become more negative (i.e., a negative zeta potential). At the isoelectric point (IEP) pH≈3.4, the pure PSf membrane has a net charge of zero (i.e., zeta potential=0 mV). The IEP values increased to pH=4.2-4.8 with the addition of PPy nanoparticles. More importantly, either positively charged at low pH due to the protonation or negatively charged at higher pH due to deprotonation, the nanocomposite membranes demonstrate much higher zeta potentials compared to the pure PSf membranes. Additionally, as the PPy nanoparticle loading was increased, the nanocomposite membranes became more highly charged. Clearly, the addition of PPy nanoparticles has promise for improving separation efficiency of PSf membranes because hydrophilicity and anti-fouling capability generally increase as membrane surfaces become more hydrophilic, energetic, and charged (Lind et al. Langmuir 2009, 25(17): 10139-10145; Kim et al. Destination 2007, 202(1-3): 333-342; Crittenden et al. (2005). Water Treatment: Principles and Design (2^{nd} ed) Hoboken: John Wiley & Sons, Inc.).

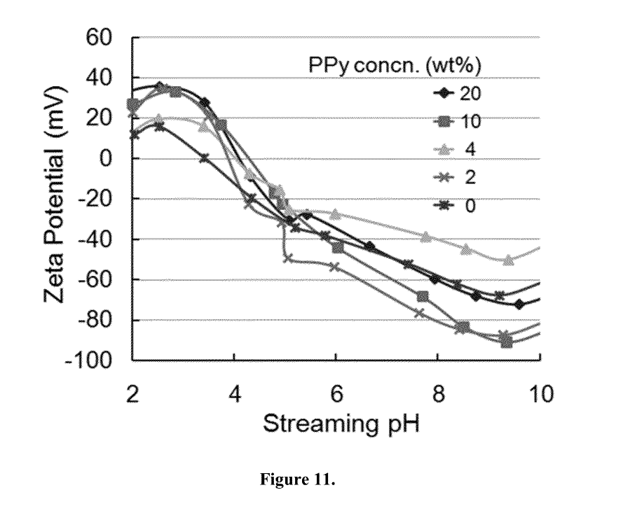

Thermal stabilities of the membranes were measured by thermogravimetric analysis (TGA) and differential TGA (DTGA) (FIG. 12). When the membranes were heated to 500° C., the pure PSf exhibits negligible weight-loss as compared to the nanocomposite which experiences a weight-loss of ˜7%. The acidic dopants of the PPy nanoparticles are volatilized upon heating, which explains why the nanocomposite membranes show a slightly lower thermal stability than the pure PSf membrane up to 500° C. When the membranes were heated to 600° C., however, the nanocomposite membranes show a slower weight-loss rate than the pure PSf membrane (11.2 vs. 17.1% min⁻¹). Moreover, when the membranes were heated from 600 to 1000° C., both the pure PSf membrane and the nanocomposite membrane exhibited only ˜5% weight-loss. The nanocomposite membrane left a more massive residue at 1000° C. in comparison to the pure PSf membrane (47 vs. 30%). However, when the weight-loss is calculated by subtraction of the PPy mass, negligible differences between membranes are observed. This implies that PPy has an insignificant influence on the thermal stability of the pure PSf matrix, likely due to the adequate miscibility between the two polymers, which is consistent with the ATR/FT-IR analysis.

3. Separation Performance

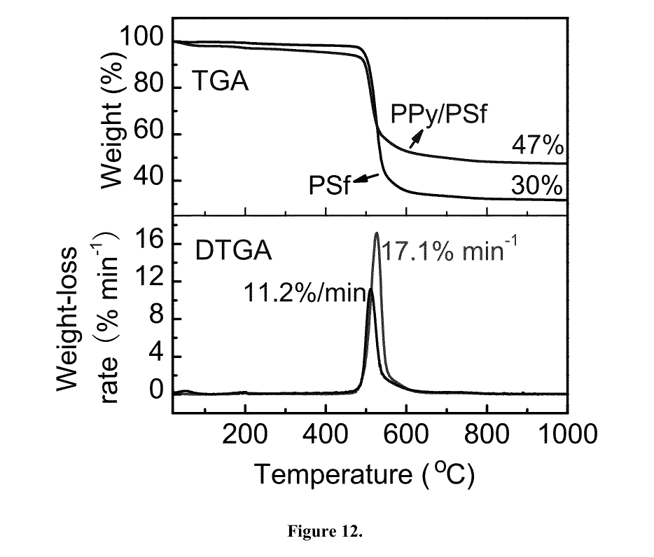

While microscopy and surface energy characterizations indicate that PPy nanoparticles produce hydrophilic films resembling filtration membranes, meaningful performance data were obtained by filtration experiments. FIG. 13 shows a simple fouling experiment, in which compacted membranes were fouled with BSA, while flux decline and BSA rejection were recorded. After collecting 5 mL of permeate, the membranes were rinsed using deionized water at room temperature in an attempt to clean the membrane surfaces and recover some of the lost permeability. Performance data from these tests are presented in Table 3. We found that the introduction of as little as 2 wt % PPy nanoparticles produces filtration membranes with markedly improved performance over the pure PSf membrane. All nanocomposite membranes showed improvements in initial, compacted, fouled, and recovered permeability with the most notable improvements in the higher PPy content membranes (46.2 vs. 4.3, 22.2 vs. 4.0, 7.9 vs. 1.9, and 12.3 vs. 2.9 μm s⁻¹ psi⁻¹, respectively). All membranes rejected BSA proteins above 82%, indicating average pore diameters of around 8 nm, consistent with expectations from microscopy (Guillen et al. J. Mater. Chem. 2010, 20(22): 4621-4628; Crittenden et al. (2005). Water Treatment: Principles and Design (2^{nd} ed) Hoboken: John Wiley & Sons, Inc.). The pure PSf membrane showed a higher BSA rejection of 94.3%.

TABLE 3
Impact of PPy Nanoparticle Loading on Membrane Performance

| | | Com- | | Recov- | | | |
|---|---|---|---|---|---|---|---|
| | Initial | pacted | Foulded | ered | Recov- | | |
| | Perme- | Perme- | Perme- | Perme- | ered | Flux | BSA |
| | ability | ability | ability | ability | Perme- | De- | Rejec- |
| Mem- | (μM s⁻¹ | (μM s⁻¹ | (μM s⁻¹ | (μM s⁻¹ | ability | cline | tion |
| brane | psi⁻¹) | psi⁻¹) | psi⁻¹) | psi⁻¹) | (%) | (%) | (%) |
| PSf | 4.3 | 4.0 | 1.9 | 2.9 | 72.4 | 54.1 | 94.3 |
| 2 wt % | 19.5 | 7.6 | 4.0 | 5.8 | 76.1 | 47.2 | 86.5 |
| PPy | | | | | | | |
| 4 wt % | 19.7 | 5.8 | 2.9 | 4.7 | 81.2 | 49.9 | 88.3 |
| PPy | | | | | | | |
| 10 wt % | 34.0 | 20.2 | 7.4 | 10.9 | 53.7 | 63.4 | 82.5 |
| PPy | | | | | | | |
| 20 wt % | 46.2 | 22.5 | 7.9 | 12.3 | 54.6 | 65.1 | 83.2 |
| PPy | | | | | | | |

A lower relative flux decline upon BSA fouling was observed in membranes containing 2 and 4 wt % PPy nanoparticles. While it is tempting to attribute this observation to the hydrophilicity and surface charge improvements associated with the introduction of nanoparticles, this observation can also be explained by the greater average pore diameters present in the 2 and 4 wt % PPy nanoparticle containing membranes. Additionally, while the 10 and 20 wt % PPy membranes showed the largest relative flux decline of 63-65% upon fouling, their fouled permeability was still considerably higher than that of the pure PSf membranes (7.9 vs. 1.9 μm s⁻¹ psi⁻¹).

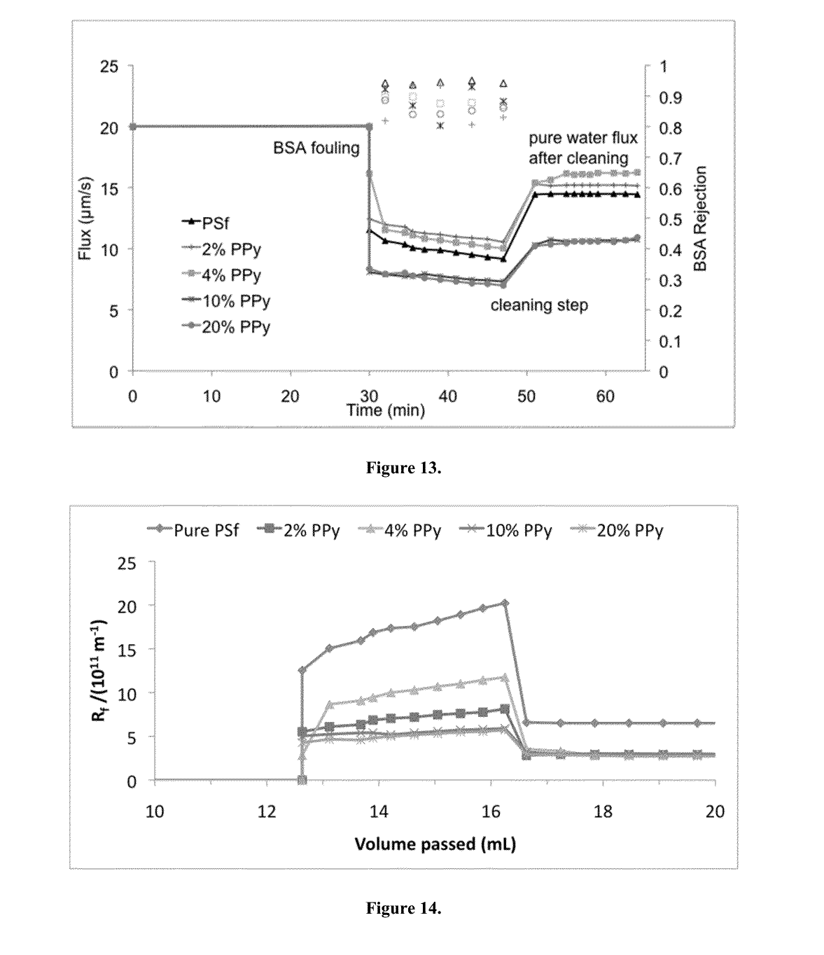

Another way to analyze the data obtained from the fouling experiments is to discuss the total hydraulic resistance present at different stages in the experiment. Initially, prior to introduction of the BSA, the total resistance to water flow through the membrane (Rₜ) is wholly attributed to the resistance of the membrane (Rₘ) itself. Upon introduction of BSA, the flux immediately declines due to fouling of the membranes. This fouling adds resistance to the system and this contribution can be described as R_{f}. At any point in the experiment the total resistance is a sum of the contributions from the membrane and the fouling layer, simply Rₜ=Rₘ+R_{f}. FIG. 14 shows membrane performance in terms of the hydraulic resistance due to the fouling layer as a function of the volume of water that has passed through the membrane during the experiment. It is clear from the figure that the pure PSf membrane experiences the largest fouling layer resistance due to BSA proteins. The cleaning step, although decidedly unsophisticated, is effective enough to restore nearly two-thirds of the permeability that was lost upon fouling with BSA. The PPy nanoparticle-containing membranes also lose permeability upon fouling with BSA, but the effect is not as severe as with the pure PSf membrane. The total irreversible fouling for the nanocomposite membranes is less than half of the corresponding value for PSf, indicating that these membranes are both resistant to fouling and also efficiently cleaned using only water.

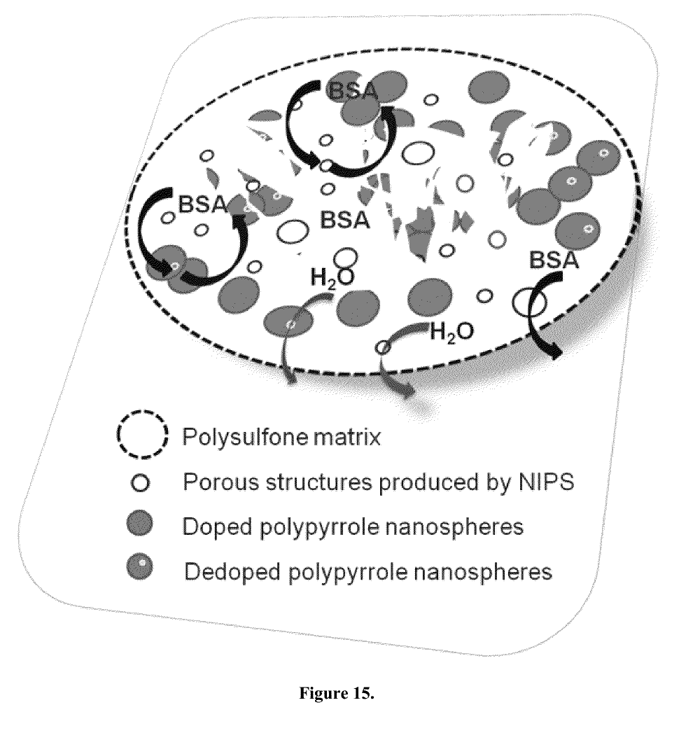

A proposed geometric structure for the PPy/PSf nanocomposite membrane is illustrated in FIG. 15. The mechanism for separation performance enhancement upon PPy nanoparticle introduction is uncertain since many factors come into play. However, in general, changes in membrane pore structure are the main contributors to membrane performance. It has been reported that high roughness leads to two changes in the modified membrane: an increase in effective filtration area and a decrease in anti-fouling properties, potentially aiding in performance enhancement (Chennamsetty et al. Langmuir 2008, 24(10): 5569-5579). Additionally, it is anticipated that the PPy nanoparticles behave as porogenic agents. Because the PPy nanoparticles used were in a protonated and oxidized form, a unique porosity is induced via dedoping during the NMP/water exchange, leading to void spaces where small molecules such as water can pass through, while larger molecules such as BSA are rejected.

### H. CONCLUSIONS

Adjusting the concentration of highly dispersible PPy nanoparticles was used to tailor the hydrophilicity, surface charge, morphology, permeability, and solute rejection of PSf nanocomposite filtration membranes. High loadings of PPy nanoparticles produce significant improvements in membrane permeability, translating into >10 times initial water permeability, >5 times compacted water permeability, >4 times BSA fouled permeability, and >4 times recovered permeability when compared to that of a pure PSf filtration membrane (46.2 vs. 4.3, 22.2 vs. 4.0, 7.9 vs. 1.9, and 12.3 vs. 2.9 μm s⁻¹ psi⁻¹, respectively); all while retaining relatively high BSA rejection (82-94%). With nanoscale pores, high porosity, improved hydrophilicity, and tunable surface charge properties, the PPy/PSf nanocomposites disclosed herein hold great promise for advanced bio-separation membranes.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method comprising
dispersing polypyrrole nanoparticles in a polymer matrix;
solution casting the polypyrrole nanoparticles dispersed in the polymer matrix, thereby forming a polypyrrole-nanoparticle composite membrane.

2. The method of claim 1, wherein the polypyrrole-nanoparticle composite membrane is solution cast onto a support structure.

3. (canceled)

4. The method of claim 1, wherein the polypyrrole nanoparticle composite membrane is formed by phase inversion.

5. The method of claim 2, wherein the support structure is a nonwoven support fabric.

6. (canceled)

7. The method of claim 1, wherein the polymer matrix is in a suspension or a solution.

8. (canceled)

9. The method of claim 1, wherein the solution casting is nonsolvent induced phase separation.

10-12. (canceled)

13. The method of claim 1, further comprising polymerizing a thin film onto a surface of the polypyrrole-nanoparticle composite membrane.

14. (canceled)

15. The method of claim 1, wherein the polymer matrix comprises polysulfone.

16. A filtration membrane prepared by the method of claim 1.

17. A membrane comprising:
(a) a polymer matrix; and
(b) polypyrrole nanoparticles dispersed within the polymer matrix.

18. The membrane of claim 17, wherein the membrane further comprises a support structure.

19. The membrane of claim 18, wherein the support structure is a nonwoven support fabric.

20. The membrane of claim 17, wherein the membrane is a hollow fiber membrane.

21. The membrane of claim 17, wherein the polymer matrix comprises polysulfone, sulfonated polysulfone, polyethersulfone, sulfonated polyethersulfone, polyaniline, polyaniline co-polymers, polyacrylonitrile, polyvinylidene fluoride, polytetrafluoroethylene, other fluorocarbon derivatives, or a mixture thereof.

22-25. (canceled)

26. The membrane of claim 17, further comprising a polymer thin film on a surface of the membrane.

27. (canceled)

28. The membrane of claim 17, wherein the polypyrrole nanoparticles are present in an amount from about 0.1 wt % to about 30 wt %.

29. The membrane of claim 17, wherein the polypyrrole nanoparticles have a diameter of from about 75 nm to about 240 nm.

30. (canceled)

31. The membrane of claim 17, wherein the membrane has an average thickness of from about 75 μm to about 150 μm.

32. The membrane of claim 17, wherein the membrane has an RMS surface roughness of less than about 10 nm.

33. The membrane of claim 17, wherein the membrane has a pure water equilibrium contact angle of less than about 60°.

34. A method for purifying water comprising:
(a) providing the filtration membrane of claim 17, wherein the membrane has a first face and a second face;
(b) contacting the first face of the membrane with a first solution of a first volume having a first solute concentration at a first pressure; and
(c) contacting the second face of the membrane with a second solution of a second volume having a second solute concentration at a second pressure;
wherein the first solution is in fluid communication with the second solution through the membrane;
wherein the first solute concentration is higher than the second solute concentration, thereby creating an osmotic pressure across the membrane; and
wherein
(i) the first pressure is sufficiently higher than the second pressure to overcome the osmotic pressure, thereby increasing the second volume and decreasing the first volume; or
(ii) the first pressure is lower than the second pressure, thereby decreasing the second volume and increasing the first volume.

35. (canceled)

36. A method for concentrating a solute comprising:
(a) providing the filtration membrane of claim 17, wherein the membrane has a first face and a second face;
(b) contacting the first face of the membrane with a first mixture of a first volume having a first solute concentration at a first pressure; and
(c) contacting the second face of the membrane with a second mixture of a second volume having a second solute concentration at a second pressure;
wherein the first solution is in fluid communication with the second solution through the membrane;
wherein the first solute concentration is higher than the second solute concentration, thereby creating an osmotic pressure across the membrane; and
wherein
(i) the first pressure is sufficiently higher than the second pressure to overcome the osmotic pressure, thereby increasing the first solute concentration and decreasing the second solute concentration; or
(ii) the first pressure is lower than the second pressure, thereby decreasing the first solute concentration and increasing the second solute concentration.

37. (canceled)
